(19) United States
(12) Patent Application Publication
(10) Pub. No.: US 2022/0250297 A1
(43) Pub. Date: Aug. 11, 2022

(54) PROCESS OF MANUFACTURING FOOT MAT

(71) Applicants: SAURABH KAPOOR, Delhi (IN); GAURAV KAPOOR, Bhopal (IN)

(72) Inventors: SAURABH KAPOOR, Delhi (IN); GAURAV KAPOOR, Bhopal (IN)

(21) Appl. No.: 17/623,566

(22) PCT Filed: May 15, 2019
(86) PCT No.: PCT/IN2019/050390

§ 371 Date: Dec. 28, 2021

(30) Foreign Application Priority Data
Apr. 2, 2019 (IN) 201911013308

(51) Int. Cl. B29C 45/16

(52) U.S. Cl. CPC B29C 45/16; B29L 2031/3017; B29K 2995/0021

(57) ABSTRACT

A process of manufacturing a foot mat is disclosed. The process includes providing a mold containing a plurality of first and second cavities, pouring a first solution of predefined colors in the plurality of first cavities of the mold and injection molding of a second solution in the plurality of second cavities of the mold to form a foot mat.

### CROSS REFERENCES TO RELATED APPLICATIONS

This application claims priority to PCT Application Number PCT/IN2019/050390 entitled “PROCESS OF MANUFACTURING FOOT MAT” and filed on May 15, 2019, for Saurabh Kapoor, et al., which is incorporated herein by reference in its entirety for all purposes.

### FIELD OF INVENTION

The present invention relates to a foot mat, more specifically the present invention relates to a method of manufacturing the foot mat.

### BACKGROUND

Foot mats are crucial accessories of an automobile. Foot mats for automotive applications are utilized in a demanding environment. They are needed to provide a rugged surface on a foot space of the automobile. Further, the foot mats are used to retain various chemicals, and debris brought in from outside as well as spilled by the passengers onto the floor of the automobile.

Conventionally, foot mats are manufactured by the process of injection molding. In the said process, a thermoplastic solution is injected into a mold using injection molding. The mold is then allowed to dry and further processed to manufacture the foot mat. However, the conventional process is more complex and/or cost intensive. The conventional method may require high tool cost. Therefore, there exists a need for an easy and/or less expensive process to manufacture foot mats.

### SUMMARY

The present invention discloses a process for manufacturing a foot mat. The process includes providing a mold containing a plurality of first and second cavities, pouring a first solution of predefined colors in the plurality of first cavities of the mold and injection molding of a second solution in the plurality of second cavities of the mold to form a foot mat.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale.

FIG. 1a represents an upper side of a foot mat in accordance with an embodiment of the present invention.

FIG. 1b represents a lower side of the foot mat in accordance with an embodiment of the present invention.

FIG. 1c represents an exploded view of the lower side of the foot mat in accordance with an embodiment of the present invention.

FIG. 2 represents a flow chart involved in manufacturing of a foot mat in accordance with an embodiment of the present invention.

FIG. 3 represents a mold in accordance with an embodiment of the present invention.

### DETAILED DESCRIPTION OF THE DRAWINGS

Prior to describing the invention in detail, definitions of certain words or phrases used throughout this patent document will be defined: the terms “include” and “comprise”, as well as derivatives thereof, mean inclusion without limitation; the term “or” is inclusive, meaning and/or; the phrases “coupled with” and “associated therewith”, as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; Definitions of certain words and phrases are provided throughout this patent document, and those of ordinary skill in the art will understand that such definitions apply in many, if not most, instances to prior as well as future uses of such defined words and phrases.

Wherever possible, same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Particular embodiments of the present disclosure are described herein below with reference to the accompanying drawings, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The present invention relates to a foot mat and a method of manufacturing thereof. The foot mat may be placed over an underlying surface. For example, the foot mat is placed over a floor of a vehicle and utilized as a car mat. However, it should be acknowledged that the foot mat of the present invention may be used for varied applications which remain within the scope of present invention. For example, the foot mat may also be used as, without limitation, a greeting mat, a freight mat, a trunk mat, etc.

In an embodiment, the foot mat of the present invention is manufactured by pouring a molten first solution in a mold followed by injection molding of a molten second solution in the same mold. The aforesaid method of the present invention may be an easy, cost-effective process in terms of tool cost. For example, the mold employed for manufacturing the foot mat is a simple design and/or less expensive. Further, the aforesaid process only employs one mold to manufacture a foot mat, thereby further reduce the cost incurred perform the process.

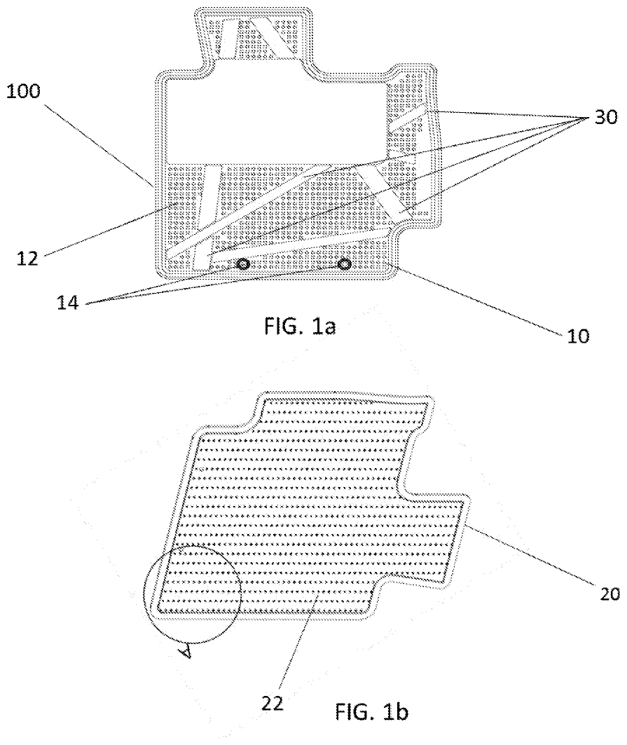

Now referring specifically to drawings, FIG. 1a represents a foot mat 100. The foot mat 100 of the present invention may include one or more properties, without limitation, anti-skid, anti-spillage, durability etc. The foot mat 100 may be made of any durable material known in the art such as without limitation polymers, fibers, metals, etc. The polymers may include without limitation one or more of a rubber, polyvinyl chloride (PVC), thermoplastic elastomer (TPE), thermoplastic olefin (TPO). In an embodiment, the foot mat 100 is made of polyvinyl chloride (PVC). The dimensions of the foot mat 100 may correspond to the dimension of the underlying surface for which the foot mat 100 is to be employed.

The shape of the foot mat 100 may be any shape known in the art such as circular, rectangular, triangular, etc. The shape of the foot mat 100 may or may not correspond to the underlying surface for which the foot mat 100 is to be employed. The foot mat 100 can be manufactured in any shape as per requirement. In an embodiment, the foot mat is of a rectangular shape.

The foot mat 100 includes an upper side 10 (as depicted in FIG. 1a) and a lower side 20 (as depicted in FIG. 1b). The upper side 10 of the foot mat 100 may include a smooth surface or a rough surface having a predefined embossed surface. The predefined embossed surface may correspond to without limitation an art decoration, trademark or brand logo etc. The embossed surface on the upper side 10 of the foot mat 100 may be provided in same and/or different colors as per requirement of a customer. In an exemplary embodiment, the foot mat 100 includes a plurality of rectangular embossed surface 30 on the upper side 10. In another embodiment, the upper side 10 of the foot mat 100 may include a plurality of circular embossed surfaces 12. Also, the foot mat 100 may include a at least two holes 14. The holes 14 may be provided to fasten the foot mat 100 with an underlying surface. The fastening may be done with the help of screw.

The lower side 20 is in direct contact with the underlying surface. For example, the lower side 20 may be in contact with the floor of the automobile. The association between the lower side 20 and the underlying surface may be with the help of any attachment means. The association may be a temporary attachment and/or permanent attachment. The attachment means may include without limitation glue, nails etc. In an embodiment, the lower side 20 may be a rough surface having a plurality of nail-like projections 22 (as depicted in FIG. 1c). The nail-like projections 22 may be scattered over the entire surface of the lower side 20. The nail-like projections 22 may provide better grip and/or prevent sliding of the foot mat 100 from its position.

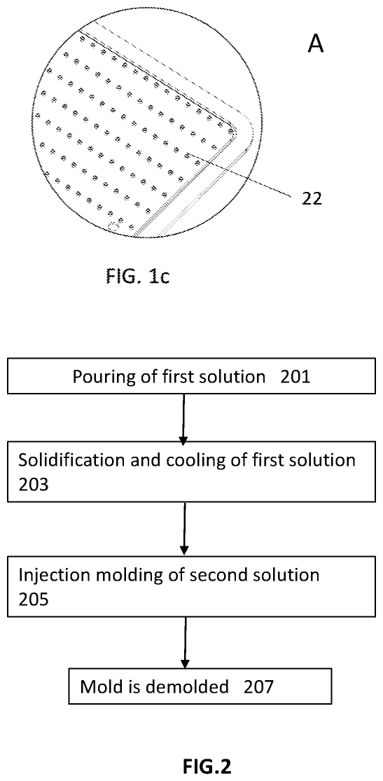

FIG. 2 illustrates a process involved in manufacturing of the foot mat 100 in accordance with an embodiment of the present invention. The process of manufacturing of the foot mat 100 may be a manual and/or an automated process. In an embodiment, the process of manufacturing of the foot mat 100 is the automated process.

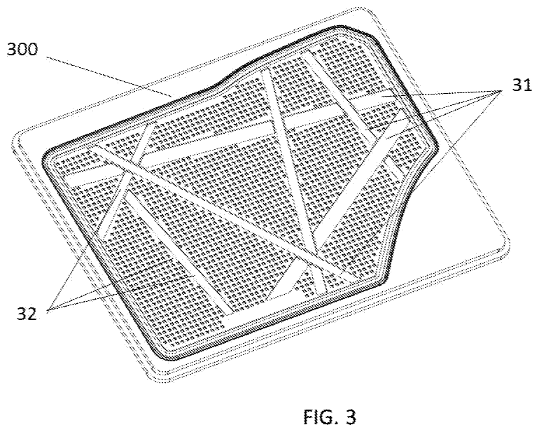

In an exemplary process, the manufacturing of the foot mat 100 commences at step 201. At the said step, a mold 300 (as depicted in FIG. 3) is filled with a first solution. The mold 300 may be made of metal such as without limitation aluminum casting alloy (LM9), aluminum alloy containing magnesium and silicon as main constituents (Al 6061). The mold 300 may include one or more first cavity for holding the first solution. The cavity may correspond to required pattern and/or design to be formed on the foot mat 100. In an embodiment, the mold 300 has a plurality of first cavities 31 for holding the first solution. Rest of the space of the mold 300 may be utilized for holding a second solution.

The first solution may be prepared by mixing predetermined components in a predefined concentration. In an embodiment, the first solution includes PVC resin, diisononyl phthalate (DINP), trimethyl pentanyl diisobutyrate (TXIB), heat resistant soya oil (HR soya Oil) and color pigmentation in a predefined concentration. The polyvinyl chloride (PVC) resin may be present in a concentration of 50% to 55%. In an embodiment, the concentration of PVC resin is 50%. The di-isononyl phthalate (DINP) may be present in a concentration of 15% to 20%. In an embodiment, the concentration of di-isononyl phthalate (DINP) is 18%. The trimethyl pentanyl diisobutyrate (TXIB) may be present in a concentration of 4% to 5%. In an embodiment, the concentration of TXIB is 5%. The HR soya oil may be present in a concentration of 0.8% to 1%. In an embodiment, the concentration of HR soya oil is 1%. The color pigmentation may be present in a concentration of 1.2% to 1.5%. In an embodiment, the concentration of color pigmentation is 1%.

The first solution is heated to a temperature of approximately 330° C. by means of without limitation a heat chamber for a predefined time duration of 1.5 to 2 mins. Heating the first solution at an aforesaid temperature results in melting of the first solution. In an embodiment, the first solution is heated for a time duration of 1 min to 2 min.

At the step 201, the mold 300 is filled with the first solution in the molten state to from a predefined pattern in the mold 300. The pouring may be a manual and/or automatic process. In an embodiment, the pouring is performed automatically by means of without limitation an automatic pneumatic injector. Various parameters involved in performing pouring may include temperature of the first solution, pressure of compressed air in the automatic pneumatic injector, etc. In an embodiment, the temperature of the first solution is 330° C. In an exemplary embodiment, the first solution is poured in the cavity 31 of the mold 300 as depicted in FIG. 3. Alternately, the pouring is done manually at ambient room conditions.

At step 203, the first solution in the mold 300 is allowed to solidify for a predefined duration of time. The predefined duration of time may be in a range of 3 to 4 minutes. Following solidification, the mold 300 may further be cooled for a predetermined time. The predetermined time for cooling may be in a range of 2 to 3 minutes. The predefined time for solidification and cooling may depend upon the type of the first solution used and its properties. As an exemplary embodiment, the mold is placed on a conveyor belt and passed through a cooling chamber one or more times to obtain a solidified mold.

At step 205, a second solution is injected in the rest of the space (excluding the plurality of first cavity 31) of the mold 300. In an exemplary embodiment, the second solution is filled in a plurality of second cavity 32 as depicted in FIG. 3. The second solution may be prepared by mixing predetermined components in a predefined concentration. In an embodiment, the second solution includes soft polyvinyl chloride (PVC), thermoplastic elastomers (TPE), thermoplastic vulcanizates (TPV), thermoplastic rubber (TPR) in a predefined concentration.

The mold 300 is subjected to a process of injection molding in an injection molding unit. The injection molding unit may be a vertical unit and/or a horizontal injection molding unit. In an embodiment, the injection molding is performed in the horizontal injection molding unit.

In order to perform injection molding, the mold 300 is fixed in an open die (not shown) of an injection molding unit (not shown). The mold 300 may be fixed manually and/or automatically in the injection molding unit. In an embodiment, the injection molding is an automotive process. In order to perform the process of injection molding, various parameters are initially set in the injection molding unit and the process of injection molding is initiated. The parameters may include cylinder temperature, injection speed, injection material temperature etc. The parameters may depend upon the type of second solution used and its properties. In an embodiment, the injection molding is performed at the injection speed of 50 to 55 MPA, at a temperature of the second solution maintained in a range of 180° C. to 220° C. The injection molding may be performed for a predefined of period of time in a range of 30 sec to 45 sec.

At the step 207, the mold 300 is allowed to cool at a room temperature for a time duration of 1 minute to 1.5 minutes. In an embodiment, the predefined period of time is 1 minute. Lastly, the mold 300 is demolded to obtain the finished foot mat 100.

The foregoing description of preferred embodiments of the present disclosure provides illustration and description, but is not intended to be exhaustive or to limit the disclosure to the precise form disclosed. Modifications and variations are possible in light of the above teachings or may be acquired from practice of the disclosure.

No element, act, or instruction used in the description of the present disclosure should be construed as critical or essential to the invention unless explicitly described as such. Also, as used herein, the article “a” is intended to include one or more items. Where only one item is intended, the term “one” or similar language is used.

We claim:

1. A process of manufacturing a foot mat, the process comprising:
providing a mold containing a plurality of first and second cavities;
pouring a first solution of predefined colors in the plurality of first cavities of the mold; and
injection molding of a second solution in the plurality of second cavities of the mold to form a foot mat.

2. The process of manufacturing a foot mat as claimed in claim 1 wherein the pouring is performed by an automatic pneumatic injector.

3. The process of manufacturing a foot mat as claimed in claim 1 wherein the pouring is performed manually.

4. The process of manufacturing a foot mat as claimed in claim 1 wherein the injection molding is performed by a horizontal injection molding unit.
